(19) United States
(12) Patent Application Publication
(10) Pub. No.: US 2006/0268787 A1
(43) Pub. Date: Nov. 30, 2006

(54) Method and system for controlling the transmission power of at least one node in a wireless network

(75) Inventors: Guenael T. Strutt, Sanford, FL (US); Shyamal Ramachandran, Maitland, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MeshNetworks, Inc., Maitland, FL (US)

(21) Appl. No.: 11/138,241

(22) Filed: May 24, 2005

(51) Int. Cl. H04B 7/216

(52) U.S. Cl. 370/335; 455/13.4; 455/522

(57) ABSTRACT

A method for controlling packet transmission power by a node in a wireless communication network, the method comprising: determining respective values for a number of sample data rates collected; determining a target data rate, wherein the target data rate is a weighted average of the respective values; and adjusting packet transmission power based on a result of a comparison of an average data rate in current traffic and channel conditions to the target data rate.

### BACKGROUND OF THE INVENTION

1. Field of the Invention

The present invention relates to a method and system for controlling the transmit power of at least one node in such a way as to obtain a performance equal to the one that would be obtained at maximum power. The power control algorithm utilized in the context of the present invention is platform-independent and does not require accurate measurements or the exchange of redundant signaling messages. Moreover, the power control algorithm utilized in the context of the present invention utilizes feedback provided by higher protocol layers and can be easily implemented over low-cost radios. An objective of power control is to lower the transmit power of a node as much as possible while maintaining the best data rate possible.

2. Description of the Related Art

In recent years, a type of mobile communications network known as an “ad-hoc” network has been developed. In this type of network, each mobile node is capable of operating as a base station or router for the other mobile nodes, thus eliminating the need for a fixed infrastructure of base stations.

More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN), and on other networks such as the Internet. Details of these advanced types of ad-hoc networks are described in U.S. patent application Ser. No. 09/897,790 entitled “Ad Hoc Peer-to-Peer Mobile Radio Access System Interfaced to the PSTN and Cellular Networks”, filed on Jun. 29, 2001, in U.S. patent application Ser. No. 09/815,157 entitled “Time Division Protocol for an Ad-Hoc, Peer-to-Peer Radio Network Having Coordinating Channel Access to Shared Parallel Data Channels with Separate Reservation Channel”, filed on Mar. 22, 2001, and in U.S. patent application Ser. No. 09/815,164 entitled “Prioritized-Routing for an Ad-Hoc, Peer-to-Peer, Mobile Radio Access System”, filed on Mar. 22, 2001, the entire content of each being incorporated herein by reference.

Since the early days of cellular phones, power control has been a topic of great interest among researchers in both academia and industry. While the past approaches and implementation methodologies utilized in attempts to solve the power control problem have varied greatly, the object of these past efforts has remained constant: to minimize interference, to maximize network capacity, and to save energy.

The significance of power control in ad-hoc networks became evident from early research on the capacity of multi-hop networks. Gupta et al., The Capacity Of Wireless Networks, IEEE Transactions on Information Theory, v. 46, no. 2 (2000), for example, introduced the notion of several simultaneous transmissions for maximizing capacity in wireless networks.

Researchers have proposed numerous schemes and algorithms for achieving power control, in an effort to minimize interference. For example, Agrawal et al., Distributed Power Control In Ad-Hoc Wireless Networks, IEEE International Symposium on Personal, Indoor, and Mobile Radio Communications, vol. 2 (2001) relates to a power control algorithm for controlling transmit power, in order to minimize the energy cost of communication between any pair of nodes in the network. However, it does not consider the effects of a reduction in transmission data rates as a result of the reduced transmission power. Narayanaswamy et al., Power Control In Ad-Hoc Networks: Theory, Architecture, Algorithm And Implementation Of The COMPOW Protocol, European Wireless (2002) discloses a COMPOW (“common power”) protocol which is based on the existence of a lowest common power in the network for a given per node throughput, during maintenance of network connectivity. It does not attempt to determine the minimum transmission power for each node in the network. Jung et al., A Power Control MAC Protocol For Ad Hoc Networks, Mobicom (2002) relates to a Power Control MAC (PCM) scheme in which data is transmitted at max power for short durations periodically and at a lower power for the rest of the time. Moreover, U.S. Pat. No. 5,450,616, filed on Oct. 6, 1993, relates to a transmit power control method that requires explicit exchange of power control signaling. Moreover, U.S. patent application Ser. No. 10/793,581, entitled “Method of Controlling Power of Wireless Access Node in a Wireless LAN System”, filed on Mar. 4, 2004, discloses a power control technique where the transmitter requests plurality of wireless devices to send a power report signal and then transmits as per the highest power report signal received. These methods require a significantly higher signaling complexity. The entire contents of all patents, patent applications, and reference cited herein are incorporate by reference.

While the transmit power control mechanisms described previously do provide a means to increase capacity in wireless networks, they fail to take a number of considerations into account. First, that reducing the transmission power of a communication device affects its ability to use its most bandwidth efficient modulation schemes, i.e. its fastest data rates. Secondly, that prediction methods based on accurate physical layer feedback such as signal-to-noise ratio are not in widespread usage because this type of detailed feedback is either unavailable or unreliable. A corollary to the unreliability of physical layer feedback is the fact that adaptive data rate selection mechanisms are typically unstable and oscillate between a number of available data rates over time, even if channel characteristics remain constant.

Accordingly, there remains a need for a system and method comprising at least one node having a power control algorithm for adjusting the transmit power of at least one node in such a way as to obtain a performance equal to the one that would be obtained at maximum power, without relying on accurate physical layer feedback.

### BRIEF DESCRIPTION OF THE DRAWINGS

These and other objects, advantages and novel features of the invention will be more readily appreciated from the following detailed description when read in conjunction with the accompanying drawings, in which:

FIG. 1 is a block diagram of an example ad-hoc wireless communications network including a plurality of nodes employing a system and method in accordance with an embodiment of the present invention;

FIG. 2 is a block diagram illustrating an example of a mobile node employed in the network shown in FIG. 1;

FIG. 3 is a flowchart showing an example of operations performed by at least one node having a power control algorithm, in accordance with an embodiment of the present invention; and

FIG. 4 is a graph depicting the relationship between the transition counter (TC) and the power adjustment decision of the power control algorithm utilized by at least one node, in accordance with an embodiment of the present invention.

### DETAILED DESCRIPTION OF THE PREFERRED EMBODIMENTS

The present invention provides a method for controlling packet transmission power by a node in a wireless network, the method comprising: determining a target data rate based on current traffic and channel conditions; establishing a transition threshold based on data rate variations; and adjusting packet transmission power based on the result of a comparison of an average data rate in current traffic and channel conditions to the target data rate.

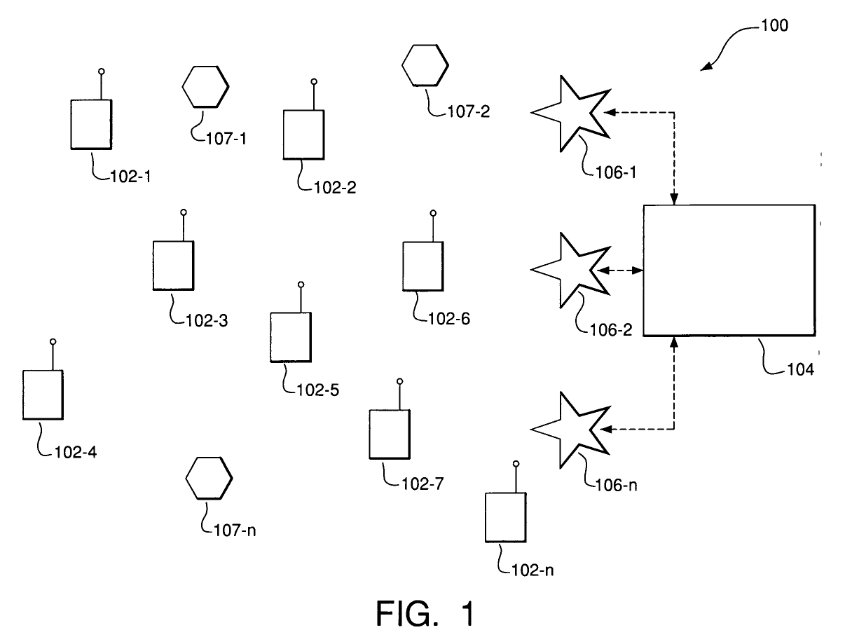

FIG. 1 is a block diagram illustrating an example of an ad-hoc packet-switched wireless communications network 100 employing an embodiment of the present invention. Specifically, the network 100 includes a plurality of mobile wireless user terminals 102-1 through 102-n (referred to generally as nodes 102 or mobile nodes 102), and can, but is not required to, include a fixed network 104 having a plurality of access points 106-1, 106-2, . . . 106-n (referred to generally as nodes 106 or access points 106), for providing nodes 102 with access to the fixed network 104. The fixed network 104 can include, for example, a core local access network (LAN), and a plurality of servers and gateway routers to provide network nodes with access to other networks, such as other ad-hoc networks, the public switched telephone network (PSTN) and the Internet. The network 100 further can include a plurality of fixed routers 107-1 through 107-n (referred to generally as nodes 107 or fixed routers 107) for routing data packets between other nodes 102, 106 or 107. It is noted that for purposes of this discussion, the nodes discussed above can be collectively referred to as “nodes 102, 106 and 107”, or simply “nodes”.

As can be appreciated by one skilled in the art, the nodes 102, 106 and 107 are capable of communicating with each other directly, or via one or more other nodes 102, 106 or 107 operating as a router or routers for packets being sent between nodes, as described in U.S. patent application Ser. Nos. 09/897,790, 09/815,157 and 09/815,164, referenced above.

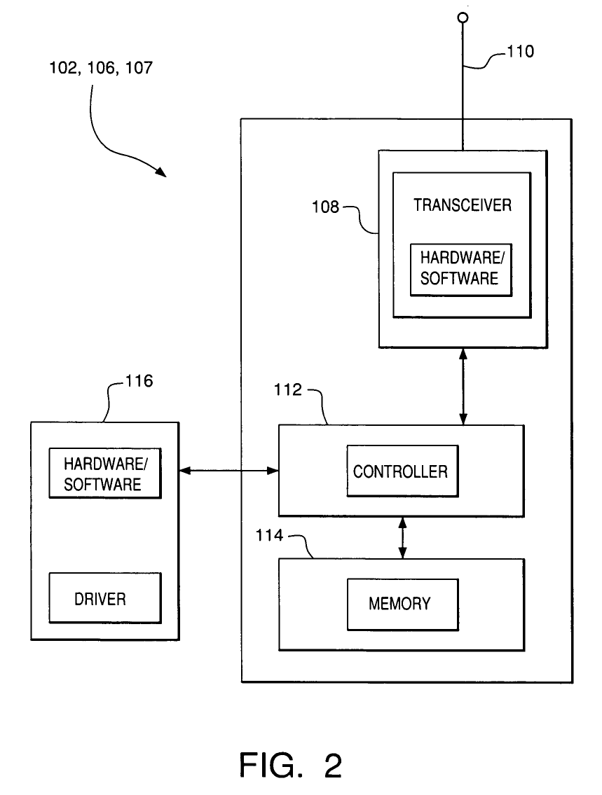

As shown in FIG. 2, each node 102, 106 and 107 includes a transceiver, or modem 108, which is coupled to an antenna 110 and is capable of receiving and transmitting signals, such as packetized signals, to and from the node 102, 106 or 107, under the control of a controller 112. The packetized data signals can include, for example, voice, data or multimedia information, and packetized control signals, including node update information.

Each node 102, 106 and 107 further includes a memory 114, such as a random access memory (RAM) that is capable of storing, among other things, routing information pertaining to itself and other nodes in the network 100. As further shown in FIG. 2, certain nodes, especially mobile nodes 102, can include a host 116 which may consist of any number of devices, such as a notebook computer terminal, mobile telephone unit, mobile data unit, or any other suitable device. Each node 102, 106 and 107 also includes the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included.

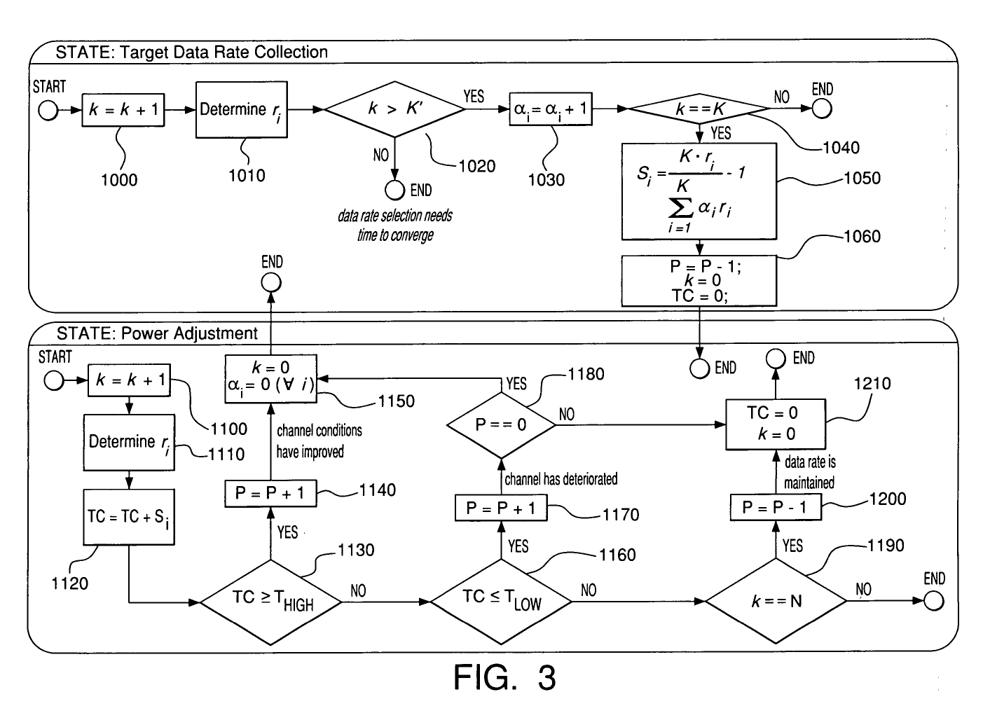

FIG. 3 shows an example of operations or procedure for power control performed by a node, in accordance with an embodiment of the present invention.

Table 1, in this regard, defines some of the power control variables used in FIG. 3. Preferably, each one of these values is associated with only one neighbor.

TABLE 1

| Description | Symbol |
|---|---|
| Selected data rate index | i |
| Selected data rate (Kbps) | rᵢ |
| Target data rate (Kbps) | r_{T} |
| Number of times a rate has been used | aᵢ |
| Normalized data rate discrepancy | Sᵢ |
| Transition counter | TC |
| Power index | P |
| Sample index | k |

Table 2 defines the other power control variables used in FIG. 3. Preferably, these values are set by the system integrator and are used to determine the transmit power required to reach each neighbor.

TABLE 2

| Description | Symbol |
|---|---|
| Sample index | k |
| Number of samples for data rate conservation | N |
| Number of samples collected before target rate determination | K' |
| Number of samples for target rate determination | K |
| Upper threshold for data rate conservation | T_{high} |
| Lower threshold for data rate conservation | T_{low} |
| Data rate conservation tolerance | z |

Preferably, the first state of the power control algorithm is “target data rate collection”, as shown in the flowchart of FIG. 3. Once the number of data rates collected reaches a required number of samples, the link adaptation algorithm can then switch to a second state of the power control algorithm, which is “power adjustment”, as discussed in more detail below. Each state of the power control algorithm is discussed separately below.

State 1: “Target Data Rate Collection”

During the “target data rate collection” state, the power control algorithm shown in FIG. 3 is executed every time a data packet is sent. In Step 1000, the iteration counter k is incremented. In Step 1010. the algorithm can be informed of the data rate rᵢ in any suitable manner. Preferably, the algorithm is informed of the data rate that is being selected by the at least one node by means of a transaction summary for data packets, such as described in U.S. Patent Application Ser. No. 60/600,413 entitled “Software Architecture and Hardware Abstraction Layer for Multi-Radio Routing”, filed on Aug. 10, 2004, the entire content being incorporated herein by reference. Moreover, while the power control algorithm is well-suited for use in conjunction with the apparatus described in U.S. Patent Application No. 60/582,497, entitled “An Adaptive Rate Selection Algorithm for Wireless Networks”, filed on Jun. 24, 2004, the entire contents of which is incorporated herein by reference, a system integrator can choose to implement any suitable different data rate selection algorithm. In this regard, the power control algorithm would preferably still operate in a manner based on the data rate feedback of the transaction summary. For each data rate rᵢ selected for transmission, the link adaptation algorithm increments the associated rate counter by one (αᵢ=αᵢ+1) in Step 1030. As illustrated in step 1020, the rate counter is not updated if the number of collected samples is below K′. This ensures that the data rate selection algorithm has the time to converge after a change of transmit power, especially if the data rate selection is based on receive signal strength (which would invariably be affected by a change in transmit power). Once the number of collected samples k reaches its maximum value K (Step 1040), the link adaptation algorithm executes Step 1050 and Step 1060 before switching to the “power adjustment” state. For the next data packet sent, the algorithm will start at Step 1100, in the “power adjustment” state. However, before entering this state, in Step 1050 the link adaptation algorithm preferably determines the adjustment values (Sᵢ) associated with each data rate. These adjustment values depend on the data rate values (rᵢ, in Kbps) and the target data rate (r_{T}, in Kbps).

The target data rate is the weighted average of all selected rates:

$${r}_{T} = \frac{{\sum }_{i = 1}^{K} {α}_{i} {r}_{i}}{K}$$

Each available data rate is associated with a normalized data rate discrepancy, which is the ratio of the difference between the data rate and the target rate by the target data rate:

$${S}_{i} = \frac{{r}_{i} - {r}_{T}}{{r}_{T}} = \frac{{r}_{i}}{{r}_{T}} - 1$$

After the normalized data rate discrepancies Sᵢ have been determined for all data rates (Step 1050), the link adaptation algorithm preferably lowers the transmit power index P and initializes the sample counter and the transition counter (Step 1060). It then enters the “power adjustment” state of the power control algorithm.

State 2: “Power Adjustment”

Power is preferably adjusted according to the following rules:
If the average data rate is lower than the target data rate (Step 1160), the power is increased (Step 1170) and the target remains the same.
If the average data rate is the same as the target data rate, within a tolerance of ±z (Step 1190), the power is decreased (Step 1200) and the target remains the same.

Alternatively, the tolerance can be asymmetrical: +Z_{high} and −z_{low}.
If the average data rate is higher than the target data rate (Step 1130), the power is increased (Step 1140) and the target data rate is reacquired.

Every time a data packet is sent, the link adaptation algorithm updates the sample index counter k (Step 1100), selects a data rate rᵢ (Step 1110) and increments the transition counter TC by the normalized data rate discrepancy Sᵢ corresponding to data rate rᵢ (Step 1120).

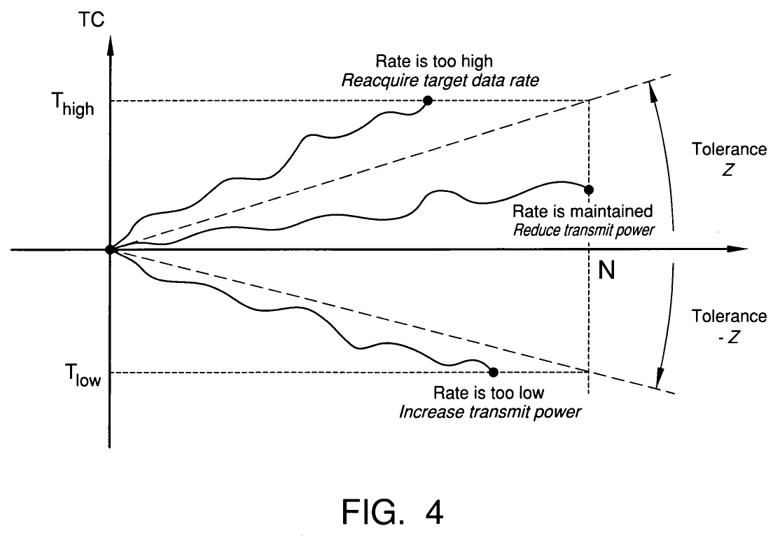

To determine if the data rate is higher, lower, or equal to the target data rate, the transition counter is compared to two thresholds T_{low} (Step 1160) and T_{high} (Step 1130), and the sample index counter is compared to a maximum value N (Step 1190). FIG. 4 depicts a scenario in which the transition counter TC becomes larger than the higher threshold T_{high} (i.e., “rate is too high”); in this case, the average data rate is greater than (1+z)×r_{T}. Similarly, if the transition counter TC becomes lower than the lower threshold T_{low} (i.e., “rate is too low”), then the average data rate is lower than (1−z)×r_{T}. The link adaptation algorithm allows for z to be asymmetrical: the tolerance to high data rates can be higher than the tolerance to low data rates if necessary. The transition counter thresholds T_{high} and T_{low} are derived from z and N. If the transition counter reaches T_{high} or T_{low} after exactly N samples, this indicates that the average data rate is at the limit of the data rate tolerance (1±z)×r_{T}. The transition counter represents the discrepancy between the average data rate and the target data rate, by cumulating the normalized data rate discrepancies Sᵢ. Thus, the power control algorithm does not actually calculate the average data rate: this allows for the transition counter to be implemented in a fixed-point microprocessor or an integrated circuit. This also makes the transition counter implementation especially suitable for systems that utilize a wide range of data rates (such as 802.11g that uses 1 Mbps and 54 Mbps data rates): the order of magnitude of the data rate is irrelevant because the power control algorithm only deals with data rate discrepancies. The following equations define the relationship between the transition counter, the data rate tolerance, the average data rate, the target data rate and the maximum number of samples:

$$\frac{{\sum }_{i = 1}^{N} {r}_{i}}{N} = ( 1 \pm z ) \times {r}_{T}$$

$$TC = {\sum }_{i = 1}^{N} {S}_{i} = {\sum }_{i = 1}^{N} \frac{{r}_{i } - {r}_{T}}{{r}_{T}} = \frac{N \times ( 1 \pm z ) \times {r}_{T}}{{r}_{T}} - N = \pm z \times N$$

The transition counter thresholds are therefore equal to:
T_{high}=z×N
T_{low}=−z×N

Finally, if the number of samples reaches N (Step 1190) and transition counter TC does not reach T_{high} or T_{low} (i.e., “rate is maintained”), then the average data rate is close to the target data rate r_{T}.

If the average data rate is higher than the target data rate (Step 1130), the power is increased (Step 1140). This allows the power control algorithm to acquire a new target data rate at a higher transmit power. Indeed, the data rate cannot possibly increase if the power is reduced—therefore, the channel conditions must have changed and the algorithm must initialize the sample counter k and the data rate counters αᵢ (Step 1150) and switch back to the “target data rate collection” state.

If the average data rate is lower than the target data rate (Step 1160), the power is increased (Step 1170). This usually indicates that the lower transmit power has been reached and that the best data rate cannot be achieved anymore. Alternatively, if the conditions in the channel have deteriorated, the algorithm will reach maximum power again (Step 1180) and a new target data rate must be determined, after initializing the sample counter k and the data rate counters αᵢ (Step 1150). The algorithm then returns to the “target data rate collection” state. If the maximum power has not been reached, the algorithm remains in the “power adjustment” state and initializes the sample index counter and the transition counter (Step 1210).

If the average data rate is close to the target data rate (Step 1190), the power is reduced (Step 1200). The algorithm remains in the “power adjustment” state, and initializes the sample index counter and the transition counter (Step 1210).

In Table 3, the constants which are common to all nodes (as shown in Table 2) are given minimum, maximum and recommended values, together with an explanation of their effect on system performance. The power control algorithm presented herein is designed to operate on different types of radios regardless of their architecture, precision, measurement abilities or other factors traditionally associated with tight power control. However, the more stable the radio, and the faster the convergence rate of the data rate selection algorithm, the more stable and the faster the power control algorithm will be.

TABLE 3

| | | MINIMUM | | MAXIMUM |
|---|---|---|---|---|
| | | RECOMMENDED | RECOMMENDED | RECOMMENDED |
| CONSTANT | DESCRIPTION | VALUE | VALUE | VALUE |
| K | Number of data points to be | 256 | 256 | 1024 |
| | collected to determine the | (Low values may | | (Higher values will |
| | target data rate with a | provide erroneous | | provide (unnecessary) |
| | reasonable degree of | target estimation) | | precision) |
| | precision | | | |
| N | Number of data points to be | 64 | 64 | 512 |
| | collected to determine if the | (Low values increase | | (High values slow |
| | rate has been maintained | oscillations) | | down convergence, |
| | | | | but eliminate |
| | | | | oscillations) |
| K' | Number of data points not | 0 | 64 | 256 |
| | being processed during | (recommended if the | | |
| | target data rate collection | data rate selection is | | |
| | (this allows data rate | independent of | | |
| | selection to converge, if | receive signal | | |
| | necessary) | strength) | | |
| T_{high} | Value that must be reached | Calculated | Calculated | Calculated |
| | by TC in order to mark a | | | |
| | link as being “improved”. | | | |
| | Value is equal to N times | | | |
| | the data rate tolerance z | | | |
| T_{low} | Value that must be reached | Calculated | Calculated | Calculated |
| | by TC in order to mark a | | | |
| | link as being “degraded”. | | | |
| | Value is equal to N times | | | |
| | the data rate tolerance z | | | |
| z | Provides a fractional | .10 | .25 | .30 |
| | tolerance value. Errors in a | (too low-a value will | | (too high a value will |
| | communication channel are | cause large power | | degrade performance |
| | bursty by nature; variations | control variations) | | by allowing the |
| | in measured data rate are | | | average data rate to be |
| | therefore to be expected. | | | much lower than the |
| | | | | target) |

Tuning

The values for all the link adaptation parameters have been given for low cost radios such as 802.11-compliant radios. It is possible, however, that other values may be required for different hardware platforms.
Data rate tolerance The data rate tolerance is the fractional amount of data rate that the power control algorithm will tolerate. The transmit power will be reduced as long as the average data rate is within a fractional amount of the target data rate. If the data rate tolerance is too low, the link adaptation algorithm will determine that the data rate is maintained and, therefore, will never drop the transmit power. Preferably, the tolerance is inversely commensurate to the rate collection time: if there is little time to acquire the data rate, then more variation is to be expected and, therefore, there must be more tolerance to change. The data rate tolerance is typically set between 10% and 30%.
Unprocessed data points If the environment has changed, and the data rate selection algorithm converges slowly, it is possible that the target data rate acquisition mechanism will over- or under-estimate the actual average rate after the selection has converged. Therefore, the link adaptation algorithm might over- or under-estimate the proper transmit power. Increasing the number of unprocessed data points will overcome that problem.
Rate collection time This value can drive the target data rate collection time. It is only meaningful, in this regard, when the link adaptation algorithm is in its collection state: increasing this time does not necessarily add stability. Too small a value will cause the target data rate to vary over time.
Rate estimation time This value can drive the power control convergence time. A very low value, in this regard, will create instability, whereas a very large value will slow the convergence rate. There is a trade-off between accurate power control and the convergence time.

Although only a few exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A method for controlling packet transmission power by a node in a wireless communication network, the method comprising:
determining respective values for a number of sample data rates collected;
determining a target data rate, wherein the target data rate is a weighted average of the respective values; and
adjusting packet transmission power based on a result of a comparison of an average data rate to the target data rate.

2. The method of claim 1, further comprising decreasing packet transmission power if the weighted average is substantially equal to the target data rate.

3. The method of claim 1, further comprising increasing packet transmission power if the average data rate is lower than the target data rate.

4. The method of claim 1, further comprising increasing packet transmission power if the average data rate is higher than the target data rate, and adjusting the target data rate.

5. The method of claim 1, wherein the comparison of the average data rate and the target data rate comprises comparing a transition counter value to maximum and minimum transition counter threshold values.

6. The method of claim 5, wherein the average data rate is determined to be substantially equal to the target data rate when a predetermined number of samples has been collected, before the transition counter value becomes lower than the minimum transition counter threshold value or higher than the maximum transition counter threshold value.

7. The method of claim 5, wherein the average data rate is determined to be lower than the target data rate when the transition counter value is lower than the minimum transition counter threshold value.

8. The method of claim 5, wherein the average data rate is determined to be higher than the target data rate when the transition counter value is higher than the minimum transition counter threshold value.

9. The method of claim 5, wherein the transition counter is determined by the sum of the normalized data rate discrepancies between the sample data rates and the target data rate.

10. The method of claim 5, wherein the maximum and minimum transition counter threshold values are the product of a predetermined number of sample data rates and a data rate variation tolerance value.

11. A node, adapted for use in a wireless communication network, and which is adapted to control its packet transmission power, the node comprising:
a controller, adapted to determine the respective values for a number of sample data rates collected, determine a target data rate, wherein the target data rate is a weighted average of the respective values, and adjust packet transmission power based on a result of a comparison of an average data rate to the target data rate.

12. The node of claim 11, wherein the node is further capable of decreasing packet transmission power if the weighted average is substantially equal to the target data rate.

13. The node of claim 11, wherein the node is further capable of increasing packet transmission power if the average data rate is lower than the target data rate.

14. The node of claim 11, wherein the node is further capable of increasing packet transmission power if the average data rate is higher than the target data rate, and adjusting the target data rate.

15. The node of claim 11, wherein the comparison of the average data rate and the target data rate comprises comparing a transition counter value to maximum and minimum transition counter threshold values.

16. The method of claim 15, wherein the average data rate is determined to be substantially equal to the target data rate when a predetermined number of samples has been collected, before the transition counter value becomes lower than the minimum transition counter threshold value or higher than the maximum transition counter threshold value.

17. The node of claim 15, wherein the average data rate is determined to be lower than the target data rate when the transition counter value is lower than the minimum transition counter threshold value.

18. The node of claim 15, wherein the average data rate is determined to be higher than the target data rate when the transition counter value is higher than the minimum transition counter threshold value.

19. The node of claim 15, wherein the transition counter is determined by the sum of the normalized data rate discrepancies between the sample data rates and the target data rate.

20. The node of claim 15, wherein the maximum and minimum transition counter threshold values are the product of a predetermined number of sample data rates and a data rate variation tolerance value.
